(19) United States
(12) Patent Application Publication
(10) Pub. No.: US 2008/0107912 A1
(43) Pub. Date: May 8, 2008

(54) Multi-Layer Coated Products and Curtain Coating Process for Same

(76) Inventor: Richard A. Barcock, Buckinghamshire (GB)

Correspondence Address: FAY SHARPE LLP, 1100 SUPERIOR AVENUE, SEVENTH FLOOR, CLEVELAND, OH, 44114, US

(21) Appl. No.: 11/664,320

(22) PCT Filed: Sep. 30, 2005
(86) PCT No.: PCT/GB05/03748

§ 371 Date: Mar. 29, 2007

(30) Foreign Application Priority Data
Sep. 30, 2004 (GB) 0421685.9

(51) Int. Cl. B32B 27/30; B05D 1/30

(52) U.S. Cl. 428/500; 427/420; 428/507; 428/511

(57) ABSTRACT

The invention relates to coated products for printing on including a substrate and at least two different coatings having different properties, which comprise a low-coat layer, adjacent to the substrate, preferably pigmented, for printing properties and possibly optical properties, and a different top-coat layer, farther from the substrate, comprising optical pigments for optical effect properties, each coating having a dry coatweight ranging from 0.1 to 12 g/m². The invention also concerns a one-pass wet-on-wet multi-layer curtain coating process for producing said coated products suitable for printing on.

### FIELD OF INVENTION

The invention relates to coated products suitable for printing on and containing at least two different coatings which confer to said product high visual properties with good mechanical properties and good absorption of inks. The invention also concerns a wet-on-wet one pass multi-layer curtain coating process for producing coated products suitable for printing on. The invention also relates to the use of the above defined coated products for printing on.

### BACKGROUND OF THE INVENTION

In the manufacture of printing paper, pigmented coating compositions are applied by, for example, blade, bar, air-knife or reverse-roll type coating methods usually at speeds ranging from 200 m/min up to more than 1000 m/min. However, the above-mentioned coating methods are not contoured (with the exception of air-knife coating method) onto rough substrates which means that any irregular substrate surface will lead to non-uniform coating thickness, which may result in irregularities during the printing process. Curtain coating processes are well known for the application of one or more liquid layers onto the surface of a moving support in the field of the photography. The curtain coating process is based on free flow onto a surface from a coating head located above the surface to be coated. The coating head is defined using properties of the coating fluid, so as to obtain the most uniform possible coating film thickness in the running direction or the transverse direction of the machine. Application of multi-layers of photographic emulsions onto a substrate using curtain or slide coating technology has been widely used in photographic industries. Curtain coating processes are now being developed and used in the paper industry. Sheets with iridescent appearance comprising a layer formed by iridescent pigments mixed with hollow plastic microspheres, as well as a method for producing the same, have been disclosed in patent application WO 2004/063464 A. A method of manufacturing multilayer coated papers and paper-boards that are especially suitable for printing, packaging and labelling purposes, in which at least two curtain layers selected from aqueous emulsions or suspensions are formed into a composite, free-falling curtain and a continuous web of basepaper or baseboard is coated with the composite curtain, as well as paper or paperboard obtained by the method have been disclosed, for example, in patent application WO 02/084029 A2.

The Applicant has found that one drawback of these coated substrates is that they are not able to generate high optical effect properties while preserving good printing properties, and this at low cost requirement. There is still a need for coated products suitable for printing on which can generate high optical properties such as gloss and/or iridescent aspects, matte aspect, colour with good mechanical properties such as a better adhesion of the coating to the substrate while providing cost savings. Especially, there is a requirement for coated substrates suitable for printing on which are able to generate dual optical effects while preserving good printing properties.

The main objectives of the invention are therefore to provide a coated product suitable for printing on, containing at least two different coatings which confer to said product high visual properties with good mechanical properties and good absorption of inks.

The applicant has demonstrated that if a coating with at least two separate coating layers having different properties is produced in a wet-on-wet single pass curtain coating process on a substrate, a coated product suitable for printing with high dual optical properties such as, for example, combined high gloss and iridescent effects, becomes possible to produce at lower cost.

### INVENTION

The present invention relates to coated products suitable for printing on including a substrate and at least two different coatings having different properties comprising one coating layer adjacent to the substrate (so called low-coat layer), said low-coat layer possibly being for absorption of inks (print dry time) and other print requirements (such as optical density of printing), and one different coating layer located farther from the substrate (so called top-coat layer), said top-coat layer being for the visual properties of the product surfaces.

The invention thus provides a coated product suitable for printing on including a substrate and at least two different coatings having different properties, which is characterized in that it comprises a coating layer adjacent to the substrate, preferably pigmented, for printing properties and possibly optical properties, and a coating layer farther from the substrate comprising optical pigments for optical effect properties, both coatings having a dry coatweight ranging from 0.1 to 12 g/m².

The coated products of the invention possess good surface quality (uniform coverage), absorptivity, porosity, adhesion to the substrate, and high specific optical properties such as, for example, gloss, metallic effect and iridescence due to the positioning of the pigments.

According to the invention, the coated product comprises a coating layer adjacent to the substrate, which provides print properties to the product, and allows the adhesion of the coating to the substrate together with good surface wetting properties.

In particular, said coating layer adjacent to the substrate, preferably pigmented, so called low-coat layer, can be for adhesion of the coating to the substrate, for absorption of inks (affecting the print dry time) and other print requirements such as optical density of printing.

According to a particular case of the invention, said coating layer adjacent to the substrate (so called low-coat layer) can further possess optical properties such as gloss.

According to the invention, the coated product comprises a coating layer farther from the substrate, so called top-coat layer, imparting specific optical properties to the product surfaces such as, for example, glossy aspect, iridescent effects and/or metallic effects.

In particular, the low-coat layer according to the invention is a coating composition comprising coating pigments and binders with a dry coatweight ranging from 0.1 to 12 g/m². Preferably, the pigments of the pigmented low-coat layer are selected from calcium carbonates, clay, kaolin, talc, titanium dioxide, silica, alumina oxide, boehmite alumina, barium sulphate, zinc oxide, gypsum and mixtures thereof.

Preferably, the top-coat layer of the coated product comprises optical pigments selected from the group consisting of plastic pigments conferring gloss properties and optical variable pigments such as metallic pigments or iridescent effect pigments.

By “optical variable pigments”, it is understood in the context of the invention to include pigments that are able to demonstrate different visual effects depending on the viewing angle, in particular pigments known for their changes of reflections, tints or shades depending on the angle of observation. As optical variable pigments, it can be cited pigments able to produce effects such as metallic, iridescent, sparkling, shiny or multicolor aspects.

Said top-coat layer may additionally include other pigments such as, for example, amorphous silica or calcium carbonate to improve specific characteristics such as, for example, print quality, ink absorption, or optical properties. Generally, these pigments are used in a small amount.

Preferably, the amount of optical pigments selected from the group consisting of plastic pigments conferring gloss properties, metallic pigments and iridescent effect pigments, is between 50 and 98% by dry weight of the total top-coat layer dry coatweight

More preferably, the amount of said optical pigments is between 70 and 90% dry weight of the top-coat layer dry coatweight.

According to the invention, the different coating layers of the coated product may include binders. Preferably, the binders are chosen from a group consisting of copolymers of styrene, namely styrene-butadiene or styrene-acrylates, styrene-maleic anhydrides, polyvinyl alcohols, polyvinyl pyrrolidones, carboxymethyl celluloses, starch, protein, polyvinyl acetates, polyurethane, polyester, acrylic acid and mixture thereof.

According to the invention, the low-coat and top-coat layers each have a dry coatweight ranging from 0.1 to 12 g/m². Preferably, the top-coat layer has a coatweight ranging from 0.1 to 5 g/m² in dry weight, more preferably from 0.1 to 2.5 g/m² in dry weight. Preferably, the low-coat layer has a coatweight ranging from 0.1 to 7 g/m² in dry weight, more preferably from 0.1 to 3 g/m² in dry weight.

Preferably, the coated product according to the invention can be a high gloss coated product wherein the top-coat layer contains plastic pigments conferring gloss properties which confer a high glossy aspect to the product. Thus, the coated product for printing on includes a substrate and at least two different coatings with respectively different properties, comprising a pigmented low-coat layer, adjacent to the substrate, as previously described for printing properties, and a top-coat layer comprising plastic pigments for a highly glossy aspect of the product, said low-coat and top-coat layers having a dry coatweight ranging from 0.1 to 12 g/m². According to a preferred form of the invention, the plastic pigments conferring gloss properties are hollow plastic microspheres, which are in particular based on styrene-acrylic polymer. According to a specific case of the invention, the mean diameter of the microspheres is between 0.2 μm and 1.3 μm.

More preferably, the said top-coat layer containing hollow plastic microspheres provides a high glossy aspect to the said coated product with a top-coat layer dry coatweight ranging from 0.1 to 5 g/m².

Preferably, the coated product for printing on includes a substrate and at least two different coatings with respectively different properties, comprising a coating layer adjacent to the substrate (so called low-coat layer), preferably pigmented, imparting printing properties, and a coating layer farther from the substrate (so called top-coat layer) comprising optical variable pigments imparting specific optical effect properties to the product surfaces, said low-coat and top-coat layers having a dry coatweight ranging from 0.1 to 12 g/m².

More preferably, the optical variable pigments are iridescent effect pigments. The iridescent pigments according to the principle of the diffraction of light cause reflections that depend on the angle of observation, the colors of which cover the rainbow spectrum into which white light is split. The coated product is thus a high iridescent product suitable for printing on wherein the top-coat layer contains iridescent pigments and solely provides an high iridescent aspect to the product.

More preferably, said top-coat layer comprising iridescent pigments provides a high iridescent aspect to the product with a top-coat layer dry coatweight ranging from 0.1 to 5 g/m².

Among the iridescent substances frequently used, mention may especially be made of mother-of-pearl extracts, titanium oxide-coated mica pigments and interferential multi layer plastic pigments.

More preferably, the coated product according to the invention can be a high glossy iridescent coated product suitable for printing on wherein the low-coat layer contains further plastic pigments conferring gloss properties and the top-coat layer contains iridescent pigments.

According to one particular case of the invention, the coated product comprises a pigmented low-coat layer for printing properties, namely for absorption of ink (print dry time) and adhesion to the substrate, said pigmented low-coat layer further comprising hollow plastic microspheres for optical properties, and a top-coat layer comprising iridescent pigments for specific optical effect properties, said low-coat and top-coat layers having each a dry coatweight ranging from 0.1 to 12 g/m². Preferably in this particular case, said low-coat and top-coat layers each have a dry coatweight ranging from 0.1 to 3 g/m², more preferably a dry coatweight ranging from 0.1 to 2 g/m².

According to this particular case of the invention, when the low-coat layer of the coated product comprises plastic pigments which confer gloss properties, the iridescent aspect of the final coated product is improved. Such coating improves the iridescent effect of the coated products without changing the printability of the product.

Once coated, the coated products can, in particular for developing the glossy optical properties of the plastic pigments, be subsequently calendered by passing them into a calender comprising steel/rubber/cotton rolls and mixtures thereof. The pressure exerted is over a series of multiple nips. The calender rolls are optionally heated.

In particular, the coated product wherein the top-coat layer comprises plastic pigments conferring gloss properties, presents after calendering a gloss value, measured at 75 degrees according to ISO 2813 standard, superior or equal to 90.

According to a preferred aspect of the invention, the base substrate can be any fibrous material made from cellulose fibres and/or synthetic fibres. In its presently preferred form this aspect of the invention is implemented in paper based sheet form. However, the invention is also applicable to substrates of other materials, such as plastics in particular polyolefins. These include so-called “synthetic papers”, i.e. plastic sheet materials (namely polyethylene) manufactured so as to simulate the printability, stiffness, handling and other characteristics of natural cellulosic paper, and printable polypropylene sheet materials of the kind specially produced for graphic arts and related packaging and stationery applications. Synthetic papers are available under the trademark “Polyart®” from the company Arjobex Limited (UK). Printable polypropylene sheet materials as referred to above are available under the trademark “Priplak®” from the company PRIPLAK (France). They may be transparent, translucent or opaque, with a variety of surface textures.

The multi-layer curtain is coated onto a continuous base substrate which is either non-coated or pre-coated. The weight per square meter of the base substrate is directly dependent on the application of the product final use. In general, there is no limitation on the grammage of the substrate used, and it will be understood that the term “paper” used in this specification embraces heavier weight papers of the kind more usually referred to as “boards”. However, the grammage of the substrate before coating methods is preferably between 45 and 300 g/m².

According to a particular case of the invention, the base substrate can be pre-coated on at least one of its faces with one or several usual pigmented pre-coats. Preferably, the deposit of said pigmented pre-coat(s) is made with usual coating processes such as blade, bar, air-knife or reverse-roll type coating methods, or with a curtain coating process.

Optionally, the pre-coated base may be calendered to promote a smoother surface on which the coatings will be applied.

According to a particular case, the base substrate is a base paper wherein the grammage of the paper substrate before coating is less than or equal to 150 g/m², preferably less than or equal to 80 g/m².

In a preferred case, the base substrate is a pre-coated paper wherein the paper base has been double-side coated with a coating composition comprising coating pigments and binders, and the pre-coating weight by face is less than or equal to 40 g/m² in dry weight, preferably less than or equal to 20 g/m². In the case where a final high gloss product is desired, the pre-coated paper base is preferably calendered. In particular, the binder of the pre-coats is selected from a group consisting of copolymers of styrene, namely styrene-butadiene or styrene-acrylates, styrene-maleic anhydrides, polyvinyl alcohols, polyvinyl pyrrolidones, carboxymethyl celluloses, starch, protein, polyvinyl acetates, polyurethane, polyester, acrylic acid and mixture thereof. Preferably, the pigments of the pre-coats are selected from calcium carbonates, clay, kaolin, talc, titanium dioxide, silica, alumina oxide, boehmite alumina, barium sulphate, zinc oxide, mica, gypsum and mixtures thereof.

The invention thus provides a coated paper (web or sheet) suitable for printing on, in particular a high gloss and/or a highly iridescent paper. The invention also provides in particular a paper with a combined high gloss and iridescent aspect.

The invention also aims to provide a multi-layer curtain coating process for manufacturing the coated products suitable for printing on as above-mentioned.

So, herein is described a multi-layer curtain coating process for producing coated products suitable for printing on wherein at least two different coatings with different properties are coated simultaneously in a one-pass wet-on-wet curtain coating process.

According to a first aspect, the invention provides a multi-layer curtain coating process for producing a coated product suitable for printing on including a substrate and at least two different coatings having different properties, said coatings being applied simultaneously in a single pass onto the substrate to be coated.

More specifically, this is a process for producing a coated product suitable for printing on having optical properties comprising the simultaneous curtain coating in a wet-on-wet single pass of at least two different coatings having different properties:

a coating layer adjacent to the substrate (so called low-coat layer) preferably pigmented having printing properties and possibly optical properties, and

a different coating layer, farther from the substrate (so called top-coat layer), comprising optical pigments for optical effect properties,

onto a substrate

wherein the substrate is coated with a dry coatweight ranging from 0.1 to 12 g/m² for each one of said specific coat layers.

The applicant has surprisingly discovered that the coating of at least two separate coatings having different properties applied in a one-pass wet-on-wet coating process using the curtain coater gives clear advantages in terms of enhanced optical properties, good adhesion of the coating to the substrate, and raw material and process cost savings in comparison to the same formulations being coated in two separate passes with a curtain coating process or other coating methods, or with a single layer containing a combination of two different required properties.

Indeed, coating at least two separate coating layers having different properties simultaneously in a wet-on-wet single pass process using a slide or slot curtain coating head affords a coated product suitable for printing with high optical properties such as gloss and/or iridescent aspects, matte aspect, colour, at lower coatweight and cost.

In particular, the low-coat layer can be for absorption of inks (print dry time) and other print requirements such as optical density of printing and the top-coat layer is for enhanced optical properties (gloss, colour, mat, optical effects such as iridescent, metallic effects).

Indeed, the low-coat layer according to the invention provides print properties to the product and allows the adhesion of the coating to the substrate.

According to a particular embodiment of the curtain coating process of the invention, the top-coat layer contains plastic pigments conferring gloss properties (such as hollow plastic microspheres) and solely provides a glossy aspect to the coated product. This is achieved by coating two layers with different properties simultaneously in one pass using a curtain coater to give a product with clear advantages when compared to a product coated with a combined ‘properties’ layer in one pass. In a particular case, the low-coat layer is for absorption (print dry time) and the top-coat layer is for glossy aspect.

According to another embodiment of the curtain coating process of the invention, the top-coat layer contains iridescent effect pigments and solely provides an high iridescent aspect to the product.

In addition, it has been surprisingly found that when the low-coat layer comprising plastic pigments conferring gloss properties, and the top-coat layer comprising optical variable pigments, are applied simultaneously onto a moving substrate by a wet-on-wet single pass curtain coating process with each a low dry coatweight, the optical effect properties of the surface product are really improved without affecting the printability of the product. The term “improved” is understood to mean a high optical effect created in the surface product by said specific layers. Indeed, according to one particular case of the multi-layer wet-on-wet single pass curtain coating process of the invention, a coated product suitable for printing on having particularly high glossy iridescent aspect is provided when the low-coat layer, preferably pigmented and having printing properties, further includes plastic pigments for gloss properties, and the top-coat layer comprises iridescent effect pigments for iridescent optical effects.

According to this particular embodiment of the invention, the wet-on-wet single pass curtain coating process provides a coated product with two high value requirements, high gloss and an iridescent surface effect.

According to a particular embodiment of the invention process, the low-coat and top-coat layers each have a dry coatweight ranging from 0.1 to 5 g/m². According to one particular case, the top-coat layer has preferably a coatweight ranging from 0.1 to 2.5 g/m² in dry weight, and the low-coat layer has preferably a coatweight ranging from 0.1 to 5 g/m² in dry weight. More preferably according a particular case of the process, the low-coat and top-coat layers each have a dry coatweight ranging from 0.1 to 2 g/m².

According to an embodiment of the invention, the process further comprises a drying step of the coatings of the coated product, and the coated product thus obtained may be calendered. According to a particular embodiment of the process to generate gloss, the coated product is calendered through multiple nips comprising mixtures of steel/rubber/cotton rolls.

According to the invention, the coated product may further include one or more coating layers located below the low-coat layer, said coating layers can have specific properties such as wetting of the substrate, adhesion on the substrate, absorption of ink or gloss enhancement or usual properties such as printing properties or colour.

The invention also provides a coated product (web or sheet) suitable for printing on obtained from this process, in particular a high gloss and/or an iridescent product.

The invention also relates to the use of a coating as defined above for coating a paper made from cellulose and/or synthetic fibres, a board or plastic (sheet or web) and making it printable.

The invention will be more clearly understood with the aid of the following non-limiting examples.

### I. EXAMPLES OF COATING COMPOSITIONS HAVING PRINTING AND GLOSSY ‘FUNCTIONALITY’

Examples of coating pattern uniformity onto a paper substrate are outlined in Table 3 and examples of the printing and glossy ‘functionality’ are outlined in Table 4.

### Coating compositions

Coating compositions with two different functionalities—printing and glossy functions—which are coated onto a paper base, described below, in a one-pass wet-on-wet curtain coating process are outlined in examples 1 to 6.

Comparative Mix is a comparative coating composition (Mix 1) which contains both functionalities and will be coated on the paper base as a single layer.

Low-coat layer (Mix 2) and Top-coat layer (Mix 3) are coating compositions according to the invention which contain respectively printing functions and glossy function.

Comparative (Mix 1): Calcium carbonate pigments (82.3 kg) were dispersed in water (34.1 kg). Amorphous Silica (0.79 kg) was then dispersed into the mix for 0.5 h. Plastic pigments (33.1 kg) were then added to the mix and allowed to stir for 0.25 h. After this period of time, a polyvinyl alcohol (binder) (3.4 kg) was added to the mix and the mix was stirred for 10 min. A latex binder (15.3 kg) was then added. A rheology modifier (0.5 kg) was then added to the mix and allowed to stir for 0.5 h. An alkyl acetylenic diol surfactant (510 g) was finally added and the mix was allowed to stir for 0.5 h.

Low-coat Layer (Mix 2): Calcium carbonate pigments (64.2 kg) were dispersed in water (35.1 kg). Amorphous Silica (1.16 kg) was then dispersed in the mix for 0.5 h. A latex binder (16.9 kg) was then added. A polyvinyl alcohol binder (2.34 kg) was added and the mix allowed to stir for 10 min. A rheology modifier (0.34 kg) was then added and the mix was agitated for a further 10 min. An alkyl acetylenic diol surfactant (240 g) was then added and the mix was stirred for 0.5 h.

Top-coat Layer (Mix 3): Plastic pigments (102 kg) were added to water (5.4 kg) and the mixture was agitated for 0.25 h. A latex binder (12.6 kg) was then added to the mix and allowed to stir for 0.25 h. An alkyl acetylenic diol surfactant (300 g) was then added and the mix was allowed to stir for 0.25 h.

TABLE 1
Mix Parameters

| | Comparative | | |
|---|---|---|---|
| | Mix | Low-coat Layer | Top-coat Layer |
| Mix Parameter | (Mix 1) | (Mix 2) | (Mix 3) |
| Solids content (%) | 50 | 50.6 | 35.35 |
| Viscosity (cps)/T ° C. | 495/26.5° C. | 385/28° C. | 88/20° C. |
| Density (g/cm³) | 1.323 | 1.375 | 1.028 |
| Surface Tension | 37.4 | 42.1 | 29.1 |
| (dyne/cm) | | | |

### Paper Base (Used for Examples 1 to 6)

The paper base is a pre-coated paper substrate of 150 g/m² formed of a raw paper base which has been double-side coated and calendered (steel/steel nip). The pre-coating composition contains 75 parts of calcium carbonate, 15 parts of clay and 10 parts of latex binder, coated at 14 g/m². The physical data is documented in the following Table 2.

TABLE 2

| | Dispersive | | | | Contact | |
|---|---|---|---|---|---|---|
| | Surface | Bendtsen | Bekk | PPS | Angle (°) | Contact |
| | Energy | Roughness | Smoothness | Roughness | Bromo- | Angle (°) |
| Substrate | (Dynes/cm) | (ml/min) | (sec) | (μm) | naphthalene | Water |
| Pre-coated | 39 | 3 | 4135 | 0.62 | 81.7 | 29.8 |
| paper substrate | | | | | | |
| of 150 g/m² | | | | | | |

### Comparative Example 1 (PRIOR ART)

Example 1 is made of the Comparative Mix (Mix 1) wherein the printing and glossy ‘functionality’ are present in a single layer.

Mix 1 (Comparative Mix) was curtain coated onto the paper base at a web speed of 600 m/min to give a dry coatweight of 8 g/m². A uniform coating pattern was obtained.

The invention is outlined in the following examples 2 to 6.

### Example 2

A stable curtain was generated with Mix 2 (Low-coat layer) at a flow rate of 230 l/h (coatweight of 7 g/m² dry) onto the paper base. A curtain was then generated with Mix 3 (Top-coat layer) at a flow rate of 50 l/h (coatweight of 1.1 g/m² dry). The combined curtain (flow rate 280 l/h) from the two mixes was stable. A uniform coating pattern was obtained onto this substrate.

### Example 3

A stable curtain was generated with Mix 2 (Low-coat layer) at a flow rate of 230 l/h (coatweight of 7 g/m² dry) onto the paper base. A curtain was then generated with Mix 3 (Top-coat layer) at a flow rate of 100 l/h (coatweight of 2.2 g/m² dry). The combined curtain (flow rate 330 l/h) from the two mixes was stable. A uniform coating pattern was obtained onto this substrate.

### Example 4

A stable curtain was generated with Mix 2 (Low-coat Layer) at a flow rate of 230 l/h (coatweight of 7 g/m² dry) onto the paper base. A curtain was then generated with Mix 3 (Top-Coat) at a flow rate of 150 l/h (coatweight of 3.3 g/m² dry). The combined curtain (flow rate 380 l/h) from the two mixes was stable. A uniform coating pattern was obtained onto this substrate.

### Example 5

A stable curtain was generated with Mix 2 (Low-coat Layer) at a flow rate of 230 l/h (coatweight of 7 g/m² dry) onto the paper base. A curtain was then generated with Mix 3 (Top-Coat) at a flow rate of 200 l/h (coatweight of 4.3 g/m² dry). The combined curtain (flow rate 430 l/h) from the two mixes was stable. A uniform coating pattern was obtained onto this substrate.

### Example 6

A stable curtain was generated with Mix 2 (Low-coat Layer) at a flow rate of 230 l/h (coatweight of 7 g/m² dry) onto the paper base. A curtain was then generated with Mix 3 (top-coat) at a flow rate of 250 l/h (coatweight of 5.4 g/m² dry). The combined curtain (flow rate 480 l/h) from the two mixes was stable. A uniform coating pattern was obtained onto this substrate.

The data related to examples 1 to 6 and their coating pattern uniformity are summarised in Table 3 wherein the dry coatweight is mentioned for the low-coat layer and top-coat layer as the low+top dry coatweight.

TABLE 3
Coating Evaluation

| | | | | | Dry | |
|---|---|---|---|---|---|---|
| | | Flow Rate (l/h) | | Web | coatweight | |
| Example | | Mix | Mix | Speed | (g/m²) | |
| No. | Coating Step | Low-coat | Top-coat | (m/min) | Low + Top | Comment |
| 1 | 1-layer 1-pass | 245 | | 600 | 8 | Uniform Coating |
| | Comparative Mix | (Mix 1) | | | | |
| 2 | 2-Layers 1-Pass | 230 | 50 | 600 | 7 + 1.1 | Uniform Coating |
| | Low-coat/Top-coat | (Mix 2) | (Mix 3) | | | |
| 3 | 2-Layers 1-Pass | 230 | 100 | 600 | 7 + 2.2 | Uniform Coating |
| | Low-coat/Top-coat | (Mix 2) | (Mix 3) | | | |
| 4 | 2-Layers 1-Pass | 230 | 150 | 600 | 7 + 3.2 | Uniform Coating |
| | Low-coat/Top-coat | (Mix 2) | (Mix 3) | | | |
| 5 | 2-Layers 1-Pass | 230 | 200 | 600 | 7 + 4.3 | Uniform Coating |
| | Low-coat/Top-coat | (Mix 2) | (Mix 3) | | | |
| 6 | 2-Layers 1-Pass | 230 | 250 | 600 | 7 + 5.4 | Uniform Coating |
| | Low-coat/Top-coat | (Mix 2) | (Mix 3) | | | |

### Physical Properties of Media

The samples (examples 1-4) were calendered at 1200 pli (pounds per linear inch) (at 45° C., 50 m/min) (steel/composite) to increase the glossy aspect. As can be seen in table 4, the 2-layer 1-pass products have a higher gloss than the 1-layer 1-pass product. As the coatweight of the top-coat layer increases, the gloss values increase due to the larger concentration of plastic pigments. The adhesion to the substrate of the 2-layer 1-pass coatings (examples 2-4) is also significantly improved over the 1-layer 1-pass coating (comparative example 1).

TABLE 4
Gloss Data

| | | | | Gloss (75°) | Gloss (60°) | Gloss (20°) | |
|---|---|---|---|---|---|---|---|
| Example | | | | BYK | BYK | BYK | Adhesion |
| No. | Layer(s) | Pass | Calendered | Gardener | Gardener | Gardener | test |
| 1 | 1 | 1 | Yes | 78 | 41.2 | 3.9 | 3 |
| 2 | 2 | 1 | Yes | 97 | 73.2 | 11.2 | 1 |
| 3 | 2 | 1 | Yes | 103 | 88.1 | 15.2 | 1 |
| 4 | 2 | 1 | Yes | 105 | 98.0 | 20.8 | 1 |

Thus, the advantages of splitting the coating into functional layers to enhance the glossy aspect of the coated product can be clearly seen. Print performance of the samples from all the examples were of comparable quality to the Comparative Mix (comparative example 1).

### Microscopy Analysis

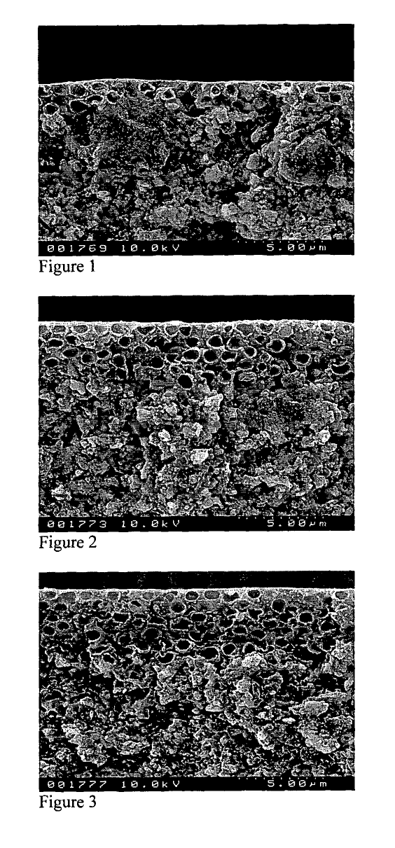

Microscopy cross-section of example 2 (FIG. 1), example 3 (FIG. 2) and example 4 (FIG. 3) according to the invention are set forth below.

As can be seen in FIGS. 1, 2 and 3, the hollow spheres for gloss enhancement during calendering are clearly visible on the top of the coating.

### II. EXAMPLES OF COATING COMPOSITIONS FOR OBTAINING COATED PRODUCTS HAVING PRINTING PROPERTIES WITH GLOSSY IRIDESCENT ASPECTS

Examples of coating pattern uniformity onto a paper base are outlined in Table 7 and examples of the printing and glossy iridescent ‘functionalities’ are outlined in Table 8.

### Coating Compositions

Coating compositions with different properties -printing, glossy and iridescent functions—which are coated onto a paper base described below in a one-pass wet-on-wet curtain coating process are outlined in the following examples.

Comparative Mix (Mix 4) is a comparative coating composition which contains all functionalities and will be coated on the paper base as a single layer.

Low-coat layer (Mix 5) and Top-coat layer (Mix 6 or Mix 7) are coating compositions according to the invention which contain respectively glossy and printing functions and iridescent function.

Comparative Mix (Mix 4): Amorphous silica (4.08 kg) was dispersed in water (61.63 kg) for 0.5 h. Plastic pigments (55.44 kg) were then added with stirring. Iridescent pigments (12.58 kg) were then added to the mix. A polyvinyl alcohol (binder) (66 kg of a 12% solution) was then added. An alkyl acetylenic diol surfactant (0.264 kg) was added and the mix was allowed to stir for 0.5 h.

Low-coat Layer (Mix 5): Amorphous silica (4.1 kg) was dispersed in water (64.4 kg) for 0.5 h. After this period of time, plastic pigments (91.4 kg at 35% solids) were added. Finally, polyvinyl alcohol (binder) (40 kg at 10% solids) was added. The mix was stirred for 0.5 h. An alkyl acetylenic diol surfactant (0.20%) was then added. The mix was allowed to stir for 0.5 h.

Top-coat Layer (Mix 6): Amorphous silica (0.83 kg) was dispersed in water (155.2 kg) for 0.5 h. Iridescent pigments (12 kg) were then added. Polyvinyl alcohol (binder) (32 kg of a 10% solution) was then added and the mix was allowed to stir for 0.5 h. An alkyl acetylenic diol surfactant (0.25%) was added and the mix was allowed to stir for 0.5 h.

Top-coat Layer (Mix 7): Amorphous silica (0.153 kg) was dispersed in water (89.75 kg) for 0.5 h. Iridescent pigments (12.60 kg) were then added. Polyvinyl alcohol (binder) (22.5 kg of a 10% solution) was then added and the mix was allowed to stir for 0.5 h. An alkyl acetylenic diol surfactant (0.25%) was then added and the mix was allowed to stir for 0.5 h.

TABLE 5
Mix Parameters

| | Comparative | Low-coat | Top-coat | Top-coat |
|---|---|---|---|---|
| | Mix | layer | layer | layer |
| Mix Parameter | (Mix 4) | (Mix 5) | (Mix 6) | (Mix 7) |
| Solids content | 22.43 | 19.26 | 7.18 | 12.3 |
| (%) | | | | |
| Viscosity (cps)/ | 225 | 234/19° C. | 32/19° C. | 46/11° C. |
| T ° C. | | | | |
| pH/T° C. | 7.9/27.3° C. | 8.5/25.6° C. | 7.8/14.7° C. | 7.7/11° C. |
| Density (g/cm³) | 1.077 | 1.0279 | 1.051 | 1.083 |
| Surface Tension | 31.3 | 30 | 28 | 27 |
| (dyne/cm) | | | | |

### Paper Base (Used for Examples 7 to 21)

The paper base is a pre-coated paper substrate of 150 g/m² formed of a raw paper base which has been double-side coated and calendered (steel/steel nip). The pre-coating composition contains 75 parts of calcium carbonate, 15 parts of clay and 10 parts of latex binder, coated at 14 g/m². The physical data are documented in the following Table 6.

TABLE 6

| | Surface | Bendtsen | Bekk | PPS |
|---|---|---|---|---|
| | Energy | Roughness | Smoothness | Roughness |
| Substrate | (Dynes/cm) | (ml/min) | (sec) | (μm) |
| paper base of | 38.5 | 15 | 241 | 2.56 |
| 150 g/m² | | | | |

### Comparative Example 7 (Prior Art)

Example 7 is made of Comparative Mix (Mix 4) wherein the printing, gloss and iridescent ‘functionalities’ are combined in one layer.

Mix 4 (Comparative Mix) was coated onto the paper base at a web speed of 600 m/min to give a dry coatweight of 5.0 g/m². A uniform coating pattern was obtained.

In the examples 8 to 10, the different layers are coated simultaneously (2-layers in 1 pass), wherein the low-coat layer (Mix 5) is coated at a dry coatweight of 2 g/m² and the top-coat layer (Mix 6) at various coatweights.

### Example 8 Invention

A stable curtain was generated with Mix 5 at a flow rate of 180 l/h (dry coatweight of 2.0 g/m²) onto the paper base. A curtain was then generated with Mix 6 at a flow rate of 120 l/h (dry coatweight of 0.5 g/m²). The combined curtain (flow rate 300 l/h) from the two mixes was stable. A uniform coating pattern was obtained onto this substrate.

### Example 9 Invention

A stable curtain was generated with Mix 5 at a flow rate of 180 l/h (dry coatweight of 2.0 g/m²) onto the paper base. A curtain was then generated with Mix 6 at a flow rate of 200 l/h (dry coatweight of 0.8 g/m²). The combined curtain (flow rate 380 l/h) from the two mixes was stable. A uniform coating pattern was obtained.

### Example 10 Invention

A stable curtain was generated with Mix 5 at a flow rate of 180 l/h (dry coatweight of 2.0 g/m²) onto the paper base. A curtain was then generated with Mix 6 at a flow rate of 250 l/h (dry coatweight of 1.2 g/m²). The combined curtain (flow rate 430 l/h) from the two mixes was stable. A uniform coating pattern was obtained.

In the following comparative examples 11 to 16, the different layers are coated separately (2-layers in 2 passes), wherein the low-coat layer (Mix 5) is coated firstly onto the paper base and dried, then the top-coat layer is coated in a separate second pass.

### Example 11 (Comparative Example)

The paper base was firstly coated with Mix 5 as low-coat layer in one pass using the curtain coating process and dried. Then it was coated with Mix 6 as top-coat layer in a second pass (using the curtain coating process) at a dry coatweight of 0.5 g/m². A stable curtain could only be formed at 260 l/h. This corresponds to a dry coatweight of about 1.1 g/m². The coating pattern was very poor and non-uniform.

### Example 12 (Comparative Example)

The paper base was firstly coated with Mix 5 as low-coat layer in one pass using the curtain coating process and dried. Then it was coated with Mix 6 as top-coat layer in a second pass (using the curtain coating process) at an increased flow rate of 400 l/m. A more stable curtain was formed at this flow rate. This corresponds to a dry coatweight of 1.68 g/m². The coating pattern was still poor and non-uniform.

### Example 13 (Comparative Example)

The paper base was firstly coated with Mix 5 as low-coat layer in one pass (using the curtain coating process) and dried. Then it was coated with Mix 6 containing 0.5% sodium alginate (as top-coat layer) in a second pass at a dry coatweight of 0.5 g/m². A stable curtain could be formed at the reduced flow rate of 140 l/h. This corresponds to a dry coatweight of 0.6 g/m². However, the coating pattern was again poor with signs of ‘skip’ coating on the substrate.

### Example 14 (Comparative Example)

The paper base was firstly coated with Mix 5 as low-coat layer in one pass using the curtain coating process and dried. Then it was coated with Mix 6 (as top-coat layer) containing 0.25% of a rheology modifier in a second pass (curtain coating process) at a flow rate of 200 l/h. This corresponds to a dry coatweight of 0.8 g/m². A stable curtain of Mix 6 was formed. However, the coating pattern was poor with signs of ‘skip’ coating on the substrate.

### Example 15 (Comparative Example)

The paper base was firstly coated with Mix 5 as low-coat layer in one pass using the curtain coating process and dried. Then it was coated with Mix 6 (as top-coat layer) containing 0.25% of a rheology modifier in a second pass (using the curtain coating process) at a flow rate of 300 l/h. This corresponds to a dry coatweight of 1.2 g/m². A stable curtain of Mix 6 was formed. However, the coating pattern was poor with signs of ‘skip’ coating on the substrate.

### Example 16 (Comparative Example)

The paper base was firstly coated with Mix 5 as low-coat layer in one pass using the curtain coating process and dried. Then it was coated with Mix 6 (as top-coat layer) containing 0.25% of a rheology modifier in a second pass (with the curtain coating process) at a flow rate of 400 l/h. This corresponds to a dry coatweight of 1.6 g/m². A stable curtain of Mix 6 was formed. However, the coating pattern was poor with signs of ‘skip’ coating on the substrate.

In the following examples 17 to 21, the different layers are coated simultaneously (2-layers in 1 pass), wherein the low-coat layer (Mix 5) is coated as a dry coatweight of 2 g/m². The top-coat layer (Mix 7) is coated at various coatweights.

### Example 17 Invention

A stable curtain was generated with Mix 5 at a flow rate of 180 l/h (dry coatweight of 2.0 g/m²) onto the paper base. A curtain was then generated with Mix 7 at a flow rate of 50 l/h (dry coatweight of about 0.35 g/m²). The combined curtain (flow rate 230 l/h) from the two mixes was stable. A uniform coating pattern was obtained.

### Example 18 Invention

A stable curtain was generated with Mix 5 at a flow rate of 180 l/h (dry coatweight of 2.0 g/m²) onto the paper base. A curtain was then generated with Mix 7 at a flow rate of 100 l/h (dry coatweight of about 0.69 g/m²). The combined curtain (flow rate 280 l/h) from the two mixes was stable. A uniform coating pattern was obtained.

### Example 19 Invention

A stable curtain was generated with Mix 5 at a flow rate of 180 l/h (dry coatweight of 2.0 g/m²) onto the paper base. A curtain was then generated with Mix 7 at a flow rate of 150 l/h (dry coatweight of about 1.04 g/m²). The combined curtain (flow rate 330 l/h) from the two mixes was stable. A uniform coating pattern was obtained.

### Example 20 Invention

A stable curtain was generated with Mix 5 at a flow rate of 180 l/h (dry coatweight of 2.0 g/m²) onto the paper base. A curtain was then generated with Mix 7 at a flow rate of 200 l/h (dry coatweight of about 1.38 g/m²). The combined curtain (flow rate 380 l/h) from the two mixes was stable. A uniform coating pattern was obtained.

### Example 21 Invention

A stable curtain was generated with Mix 5 at a flow rate of 180 l/h (dry coatweight of 2.0 g/m²) onto the paper base. A curtain was then generated with Mix 7 at a flow rate of 300 l/h (dry coatweight of about 2.07 g/m²). The combined curtain (flow rate 480 l/h) from the two mixes was stable. A uniform coating pattern was obtained.

The vacuum box (under the catch-pan) was applied during the coating trials to assist in minimizing air-entrainment in the curtain during the coating process.

TABLE 7
Coating Evaluation

| | | Flow Rate (l/h) | | | Dry | | |
|---|---|---|---|---|---|---|---|
| | | Mix | Mix | Web | Coating | Wet | |
| Example | | Low- | Top- | Speed | Weight | thickness | |
| No. | Coating Step | coat | coat | (m/min) | (g/m²) | (μm) | Comments |
| 7 | 1-Layer 1-Pass | 370 | | 600 | 5.0 | 20.8 | Uniform Coating |
| | Comparative Mix 4 | | | | | | |
| 8 | 2-Layers 1-Pass | 180 | 120 | 600 | 2.5 | 10.1/6.7 | Uniform Coating |
| | Low-coat/Top-Coat | (Mix 5) | (Mix 6) | | (2.0 + 0.5) | | |
| 9 | 2-Layers 1-Pass | 180 | 200 | 600 | 2.8 | 10.1/11.2 | Uniform Coating |
| | Low-coat/Top-Coat | (Mix 5) | (Mix 6) | | (2.0 + 0.8) | | |
| 10 | 2-Layers 1-Pass | 180 | 250 | 600 | 3.2 | 10.1/14.0 | Uniform Coating |
| | Low-coat/Top-Coat | (Mix 5) | (Mix 6) | | (2.0 + 1.2) | | |
| 11 | 2-Layers 2-Pass | | 260 | 600 | 1.1 | 14.6 | Curtain formed |
| | Top-coat | | (Mix 6) | | | | at minimum flow |
| | | | | | | | rate of 260 l/h. |
| | | | | | | | Poor coating |
| | | | | | | | uniformity |
| 12 | 2-Layers 2-Pass | | 400 | 600 | 1.68 | 22.4 | Curtain stability |
| | Top-coat | | (Mix 6) | | | | enhanced with |
| | | | | | | | flow rate of |
| | | | | | | | 400 l/h. Poor |
| | | | | | | | coating |
| | | | | | | | uniformity |
| 13 | 2-Layers 2-Pass | | 140 | 600 | 0.6 | 7.9 | Curtain formed |
| | Top-coat with 0.5% | | (Mix 6) | | | | at a minimum |
| | sodium alginate | | | | | | flow rate of 140 l/h. |
| | | | | | | | Poor coating |
| | | | | | | | uniformity |
| 14 | 2-Layers 2-Pass | | 200 | 600 | 0.81 | 11.2 | Curtain formed. |
| | Top-coat with 0.25% | | (Mix 6) | | | | Poor coating |
| | of rheology modifier | | | | | | uniformity |
| 15 | 2-Layers 2-Pass | | 300 | 600 | 1.22 | 16.8 | Curtain formed. |
| | Top-Coat with 0.25% of | | (Mix 6) | | | | Poor coating |
| | rheology modifier | | | | | | uniformity |
| 16 | 2-Layers 2-Pass | | 400 | 600 | 1.63 | 22.4 | Curtain formed. |
| | Top-Coat with 0.25% of | | (Mix 6) | | | | Poor coating |
| | rheology modifier | | | | | | uniformity |
| 17 | 2-Layers 1-Pass | 180 | 50 | 600 | 2.35 | 10.1/2.8 | Uniform Coating |
| | Low-coat/Top-Coat | (Mix 5) | (Mix 7) | | (2.0 + 0.35) | | |
| 18 | 2-Layers 1-Pass | 180 | 100 | 600 | 2.69 | 10.1/5.6 | Uniform Coating |
| | Low-coat/Top-Coat | (Mix 5) | (Mix 7) | | (2.0 + 0.69) | | |
| 19 | 2-Layers 1-Pass | 180 | 150 | 600 | 3.04 | 10.1/8.4 | Uniform Coating |
| | Low-coat/Top-Coat | (Mix 5) | (Mix 7) | | (2.0 + 1.04) | | |
| 20 | 2-Layers 1-Pass | 180 | 200 | 600 | 3.38 | 10.1/11.2 | Uniform Coating |
| | Low-coat/Top-Coat | (Mix 5) | (Mix 7) | | (2.0 + 1.38) | | |
| 21 | 2-Layers 1-Pass | 180 | 300 | 600 | 4.07 | 10.1/16.8 | Uniform Coating |
| | Low-coat/Top-Coat | (Mix 5) | (Mix 7) | | (2.0 + 2.07) | | |

Applying a coating layer with printing and gloss properties—as low-coat layer—and a coating layer with iridescent properties—as top-coat layer—in a wet-on-wet single pass process on a substrate paper using the slide curtain coating head, afforded a coated product with high glossy iridescent aspects at a lower coatweight and cost.

Coating a thin iridescent top-coat (coatweight range of 0.35 g/m² to 2.07 g/m²) with the ‘low-coat layer’ (coatweight at 2.0 g/m²) yielded a highly uniform coating pattern and allows for the iridescent pigments to remain on the coating surface orientated parallel to the substrate surface, where they are required in order to be effective for an iridescent aspect.

A flow rate of 50 l/h for the top-coat (Mix 7) example 17, gave a uniform coating profile. A noticeable iridescent aspect was observed even at 0.35 g/m². Increasing the flow rates in small increments up to 300 l/h was readily achieved and uniform coating patterns were obtained. An increase in iridescent aspect relative to the higher coatweight was observed. Coating the two ‘functional’ layers separately yielded poor coating uniformity for the iridescent top-coat formulation. The top-coat Mix 6 would only form a stable curtain at 260 l/h. However, an uneven coating pattern was obtained on the media and ‘skip’ coating was observed at the curtain impingement zone. The cause of this skip coating is likely to be due to air entrainment and curtain instability at the web speed employed. Increasing the flow rate to 400 l/h stabilized the curtain further but a poor coating pattern was still obtained. This particular top-coat could not be coated in one pass using the curtain coating module. Even increasing the viscosity of the top-coat mix with 0.5% sodium alginate (as thickening agent) (Brookfield viscosity at 204 cps at 21° C.) did not improve the coating quality (example 13). Addition of 0.25% of a rheology modifier increased the high shear and extensional viscosity of the mix, and although a stable curtain was formed, it still did not improve the coating pattern at flow rates of 200 to 400 l/h.

However, when the top-coat mix is applied in combination with the low-coat layer mix in a wet-on-wet process, a uniform coating is obtained. It is likely that the combined effective rheology of the low-coat layer and top-coat mixes allows for this uniform coating pattern.

### Colorimetry Data

Colour data of examples 7, 9, 10, 17 and 19 were determined in a (L, a, b) system with a fixed illumination angle at −45°, for angles measured from −75° to 75°.

The comparative sample (comparative example 7) shows a more yellow colour at the measured angle of 45°. Upon moving to the two-layered one-pass product, the iridescent green effect becomes more pronounced. Thus, example 9 has a 0.8 g/m² iridescent top-coat (Mix 6) onto the low-coat layer. Example 10 has a 1.2 g/m² top-coat (Mix 6) with enhanced iridescence. Applying Mix 7 as a top-coat yielded a wider colour gamut (yellow-green) for Examples 17 and 19.

### Physical Properties of Media

The samples were calendered at 1200 pli (45° C., 50 m/min) (steel/composite) to increase the gloss and the iridescent aspect. As it can be seen in Table 8, the 2-layer 1-pass products have a higher gloss than when the top-coat is applied as a separate layer (gloss values may be affected by the poor coating uniformity). As the coatweight of the top-coat increases the gloss value lowers, due to the particle size (5 to 25 μm) of the iridescent pigment, but the iridescent aspect becomes more prominent.

TABLE 8
Gloss Data

| | | | | |
|---|---|---|---|---|
| Example | | | | Gloss (75°) |
| No. | Layer(s) | Pass(es) | Calendered | BYK Gardener |

| | | | | |
|---|---|---|---|---|
| 7 | 1 | 1 | Yes | 70 |
| 8 | 2 | 1 | Yes | 75.1 |
| 9 | 2 | 1 | Yes | 68.4 |
| 10 | 2 | 1 | Yes | 62.7 |
| 11 | 2 | 2 | Yes | 49.8 |
| 13 | 2 | 2 | Yes | 60.0 |
| 14 | 2 | 2 | Yes | 29.3 |
| 15 | 2 | 2 | Yes | 26.6 |
| 17 | 2 | 1 | Yes | 79.2 |
| 18 | 2 | 1 | Yes | 78.4 |
| 19 | 2 | 1 | Yes | 74.0 |
| 20 | 2 | 1 | Yes | 64.1 |
| 21 | 2 | 1 | Yes | 50.5 |

### Print performance of the samples from all the examples were of comparable quality with the comparative example (comparative example 7). The dry-times and picking rates were also very similar.

### Microscopy (SEM) Analysis

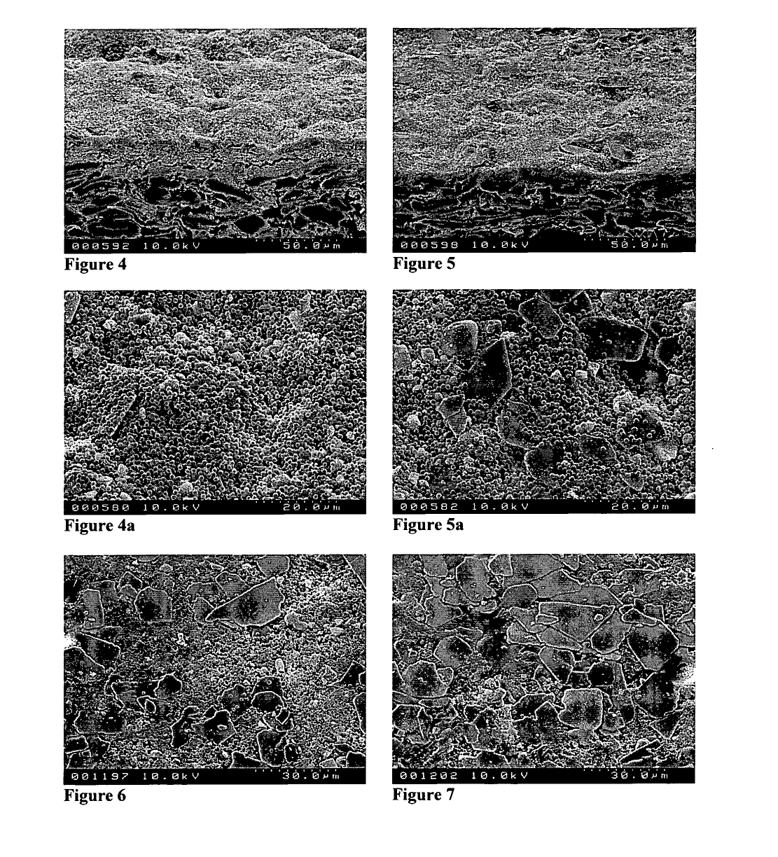

Microscopy cross-section of comparative example 7 (FIGS. 4 and 4a) and example 9 (FIGS. 5 and 5a), example 19 (FIG. 6) and example 21 (FIG. 7) according to the invention are set forth below.

As can be seen in FIGS. 5a, 6 and 7, the iridescent plate pigments of the 2-layers-1-pass iridescent papers are clearly visible on the surface of the papers. In contrast, the iridescent pigments of the 1-layer-1-pass iridescent paper are buried in the coat (FIGS. 4 and 4a).

### Test Methods

Adhesion Test—A piece of adhesive Tape (Scotch®) (1 cm×10 cm) was placed firmly onto the coated paper and then pulled away from the surface by hand. The quantity of coating deposited onto the tape was then judged and accordingly ranked 1 to 5. Rank 1 indicates no coating on the tape (excellent adhesion), rank 5 indicates that the coating is completely pulled off with the tape (poor adhesion).

Viscosity—was measured using a Brookfield RVT viscometer. The spindle speed selected was 100 rpm. Spindle size was Sp3 for Mixes of examples 1 to 6 and was either Sp2 or Sp3 for Mixes of examples 7 to 21. The temperature of the mix was recorded during the measurement of the viscosity.

Density—was measured using a 100 mL Pycnometer. The temperature was recorded during the measurement of the density.

pH—was measured using an HI 9024 Microcomputer pH meter (Hanna Instruments). The temperature was recorded during the measurement of the pH.

Solids content (%)—was measured using a CEM Labwave 9000 Microwave Moisture/Solids Analyzer.

Contact Angle—was measured with a FibroDAT 1100

Surface Tension—was measured using a DCA 132 (Wilhelmy Plate) apparatus with a platinum plate

Paper Gloss—was measured using a gloss meter at fixed angles of 20, 60, 75° (BYK Gardner GmbH)

Paper Smoothness—was measured using a Bekk Smoothness Tester and a Parker Prints Surface Tester (Messmer Instruments Ltd) (pps roughness)

Air Permeability—was measured using a Bendtsen Tester (Lorentzen & Wettre)

Rheology—flow data was measured with a CV0120 High Resolution Rheometer (Bohlin Instruments) using the parallel plate at a gap of 40 μm at 25+/−1° C. The shear rate range was 10 to 100000 s⁻¹

Effective Extensional Viscosity—was measured on a Paar Automated High Shear Viscometer HVA 6 with a capillary length of 10 mm and 5 mm and a capillary diameter of 0.6 mm.

Scanning Electron Microscope (SEM)—Hitachi S-4000 Electron Microscope.

### Mix Preparation and Coating Method

All parts are by wet weight. All formulations were mixed using a Greaves GM dispersing apparatus. The stirring was optimised to ensure good mixing but to avoid excessive air entrainment. The curtain head used was a slide-type with a width of 49 cm and a die gap of 300 μm. The curtain coating head was equipped with edge guides with running water down each side, with a vacuum suction present to remove this water at the bottom of the edge guides. The catch-pan also acts as a baffle—a mechanical barrier to limit air entrainment at the impingement zone. A suction vacuum can optionally be applied (0.3 bar) to reduce the movement across the web of the curtain at the impact zone and to limit further the onset of air entrainment. The curtain height was 150 mm from the web. The coatweight of each coated sample is determined from the known volumetric flow rate of the pump delivering the mix to the curtain head, web speed, density and % solids of the mix, and curtain width. The gravimetric coatweight can be checked by placing a 1 m² coated and uncoated substrate sample in an oven at 150° C. for 10 min and measuring the difference in weight between the two samples. It can be accurately calculated for each layer, as the person skilled in the art will know, according to the coating speed, the width of the coating head, the flow rate of each mix/layer into the coating head, the solids content and the density of this given mix.

Each mix was de-aerated prior to coating using a de-aeration equipment.

### Materials Used in Formulations

Plastic pigments: hollow plastic microspheres of bimodal distribution with a particle size of 1.3 μm and 0.2 μm, at 35% solids. These pigments act as an opacifier and enhance gloss upon calendering.

Amorphous silica: silica powder with an average particle size of 5-6 μm. The mix was dispersed in water for 0.5 h.

Iridescent pigments: iridescent ‘interference’ pigment plates of particle size range 5-25 μm.

Polyvinyl alcohol binder: the polyvinyl alcohol is 88% hydrolysed. The viscosity of a 4% solution at 25° C. is 40 cps. The polyvinyl alcohol binder was used as a 10% solution obtained by heating the polyvinyl alcohol granules with water at 95° C. for 0.5 h.

Latex binder: styrene butadiene emulsion with a particles size of 140 nm.

A surfactant: a non-ionic alkylphenyl ethoxylate surfactant which lowers dynamic surface tension.

Rheology modifier: an anionic water-in-oil emulsion of an acrylate acrylic acid copolymer.

### Printing Assessment

Printing was performed on the Heidelburg GTO52 printing press

PIRA ink dry times were measured (BASF Flashdri 3000 duct stable ink) in the Print Room. IGT Pick-Test.

1. A coated product for printing on including a substrate and at least two different coatings having different properties, said coated product comprising a low-coat layer, adjacent to the substrate, preferably pigmented, for printing properties and possibly optical properties, and a different top-coat layer, farther from the substrate, comprising optical pigments for optical effect properties, each coating having a low dry coatweight ranging from 0.1 to 12 g/m².

2. A coated product as claimed in claim 1, wherein the top-coat layer comprises optical pigments selected from the group consisting of plastic pigments conferring gloss properties and optical variable pigments.

3. A coated product as claimed in claim 1 wherein the low-coat layer comprises coating pigments and binders for printing properties.

4. A coated product as claimed in claim 3, wherein said coating pigments of the low-coat layer are selected from calcium carbonates, clay, kaolin, talc, titanium dioxide, silica, alumina oxide, boehmite alumina, barium sulphate, zinc oxide, gypsum and mixtures thereof.

5. A coated product as claimed in claim 1 wherein the top-coat layer comprises plastic pigments conferring gloss properties.

6. A coated product as claimed in claim 1 wherein the top-coat layer comprises optical variable pigments.

7. A coated product as claimed in claim 2, wherein the optical variable pigments are selected from the group consisting of metallic effect pigments, iridescent effect pigments.

8. A coated product as claimed in claim 3, wherein said pigmented low-coat layer further comprises plastic pigments for optical properties.

9. A coated product as claimed in claim 8, wherein the low-coat layer comprises plastic pigments conferring gloss properties and the top-coat layer comprises optical variable pigments.

10. A coated product as claimed in claim 9, wherein the optical variable pigments are iridescent effect pigments.

11. A coated product as claimed in claim 9, wherein the optical variable pigments are metallic effect pigments.

12. A coated product as claimed in claim 7 wherein the iridescent effect pigments are selected from the group consisting of mother-of-pearl extracts, titanium oxide-coated mica pigments and interferential multilayer plastic pigments.

13. A coated product as claimed in claim 1 wherein the substrate is a fibrous substrate or a plastic substrate.

14. A coated product as claimed in claim 13, wherein said fibrous substrate is a material based on cellulose fibers.

15. A coated product as claimed in claim 14, wherein the substrate is a paper or a board.

16. A coated product as claimed in claim 15, wherein the grammage of the paper substrate (if pre-coated, before pre-coating) is less than or equal to 150 g/m², preferably less than or equal to 80 g/m².

17. A coated product as claimed in claim 13, wherein the substrate is either a) non-coated or primed, b) pre-coated or pre-primed, or c) pre-coated and subsequently calendered.

18. A coated product as claimed in claim 1 wherein the low-coat layer has a dry coatweight ranging from 0.1 to 7 g/m² and the top-coat layer has a dry coatweight ranging from 0.1 to 5 g/m².

19. A coated product as claimed in claim 5, wherein the low-coat layer has a dry coatweight of about 7 g/m² and the top-coat layer has a dry coatweight ranging from 0.1 to 5 g/m².

20. A coated product as claimed in claim 9, wherein the low-coat layer has a dry coatweight ranging from 0.1 to 5 g/m² and the top-coat layer has a dry coatweight ranging from 0.1 to 2.5 g/m².

21. A coated product as claimed in claim 1 wherein different coatings of the coated product include binders.

22. A coated product as claimed in claim 21, wherein said binders are chosen from a group consisting of copolymers of styrene, namely styrene-butadiene or styrene-acrylates, styrene-maleic anhydrides, polyvinyl alcohols, polyvinyl pyrrolidones, carboxymethyl celluloses, starch, protein, polyvinyl acetates, polyurethane, polyester, acrylic acid and mixture thereof.

23. A coated product as claimed in claim 5, wherein said coated product with a top-coat layer comprising plastic pigments conferring gloss properties has after calendering a gloss value, measured at 75 degrees according to ISO 2813 standard, superior or equal to 90.

24. A process for producing a coated product suitable for printing on having optical properties comprising the simultaneous curtain coating in a wet-on-wet single pass of at least two different coatings having different properties:
a low-coat layer, preferably pigmented, having printing properties and possibly optical properties, and
a different top-coat layer, comprising optical pigments for optical effect properties,
onto a substrate
wherein the substrate is coated with a dry coatweight ranging from 0.1 to 12 g/m² for each one of said specific coat layers.

25. A process as claimed in claim 24, wherein the coatings are further dried.

26. A process as claimed in claim 24, wherein the substrate is a material based on cellulose fibers.

27. A process as claimed in claim 24, wherein the substrate is a plastic film or sheet.

28. A process as claimed in claim 24, wherein that the low-coat layer comprises coating pigments and binders for printing properties.

29. A process as claimed in claim 28, wherein said coating pigments of the low-coat layer are selected from calcium carbonates, clay, kaolin, talc, titanium dioxide, silica, alumina oxide, boehmite alumina, barium sulphate, zinc oxide, gypsum and mixtures thereof.

30. A process as claimed in claim 24, wherein the top-coat layer comprises optical pigments selected from the group consisting of plastic pigments conferring gloss properties and optical variable pigments.

31. A process as claimed in claim 30, wherein the top-coat layer comprises plastic pigments conferring gloss properties.

32. A process as claimed in claim 31, wherein for developing the glossy optical properties of the plastic pigments of the top-coat layer, the coated product thus obtained after drying is subsequently calendered.

33. A process as claimed in claim 30, wherein the top-coat layer comprises optical variable pigments.

34. A process as claimed in claim 33, wherein optical variable pigments are selected from the group consisting of metallic effect pigments, iridescent effect pigments.

35. A process as claimed in claim 24, wherein the said pigmented low-coat layer further comprises plastic pigments for optical properties.

36. A process as claimed in claim 35, wherein the optical variable pigments are iridescent effect pigments.

37. A process as claimed in claim 24, wherein the low-coat layer has a dry coatweight ranging from 0.1 to 7 g/m² and the top-coat layer has a dry coatweight ranging from 0.1 to 5 g/m².

38. A process as claimed in claim 24, wherein it further comprises drying the obtained coated product.

39. A coated product for printing on comprising:
a substrate coated with at least two different coatings having different properties, said coatings comprising: (i) a pigmented low-coat layer adjacent to the substrate for printing properties and optical properties; and, (ii) a different top-coat layer farther from the substrate as compared to the low-coat layer, said top-coat layer comprising optical pigments for optical effect properties, said low-coat layer and said top-coat layer each having a dry coatweight ranging from 0.1 to 12 g/m².

40. A process for producing a coated product suitable for printing on having optical properties comprising the simultaneous curtain coating onto a substrate in a wet-on-wet single pass of at least two different coatings having different properties, said at least two different coatings comprising:
a pigmented low-coat layer having printing properties, and
a different top-coat layer, comprising optical pigments for optical effect properties,
wherein the substrate is coated with a dry coatweight ranging from 0.1 to 12 g/m² for each of said low-coat layer and said top-coat layer.
